(19) United States
(12) Patent Application Publication
(10) Pub. No.: US 2020/0335021 A1
(43) Pub. Date: Oct. 22, 2020

(54) DISPLAY DEVICE AND DRIVING METHOD THEREOF

(71) Applicant: SHENZHEN CHINA STAR OPTOELECTRONICS TECHNOLOGY CO., LTD., Guangdong (CN)

(72) Inventor: Xiaoli FU, Guangdong (CN)

(21) Appl. No.: 16/609,843

(22) PCT Filed: Jul. 3, 2019
(86) PCT No.: PCT/CN2019/094617

§ 371 Date: Oct. 31, 2019

(30) Foreign Application Priority Data
Apr. 22, 2019 (CN) 201910325691.5

(51) Int. Cl. G09G 3/20

(52) U.S. Cl. CPC G09G 3/20; G09G 2300/0426; G09G 2310/0275; G09G 2310/0297; G09G 2300/08

(57) ABSTRACT

A display device and a driving method are provided. The display device includes a display panel, having a multiple multiplex module and data lines connected to the multiple multiplex module, and a flip-chip film connected to the display panel. The multiple multiplex module includes switching thin-film transistors corresponding to data lines. For each switching thin-film transistor (TFT), a source electrode is connected to the flip-chip film, a drain electrode is connected to a data line, and a gate electrode receives a switching control signal. Switching TFTs are divided into switching TFT groups every M switching TFTs (M is a positive integer not less than 2). A switching TFT group receives a switching control signal, and switching control signals corresponding to switching TFT groups are different. The data lines are controlled to accomplish time-sharing multiplex flip-chip films. A number of flip-chip films is saved, and manufacturing costs are reduced.

### BACKGROUND OF DISCLOSURE

### 1. Field of Disclosure

The present disclosure relates to the field of display technology, and more particularly, to a display device and a driving method thereof.

### 2. Description of Related Art

Currently, thin-film transistors (TFTs), which are main driving components for liquid crystal display (LCD) devices and active matrix organic light-emitting diode (AMOLED) display devices, directly relate to display performance of flat-panel display devices.

Most of the liquid crystal display devices in the present market are backlit liquid crystal display devices including liquid crystal display panels and backlight modules. The working principle of the liquid crystal display panels is that injecting liquid crystal molecules between a thin-film transistor (TFT) array substrate and a color filter (CF) substrate, and then applying a pixel voltage and a common voltage to two substrates respectively. Electric fields formed between the pixel voltage and the common voltage control rotating directions of the liquid crystal molecules, causing the light of the backlight modules to emit so that pictures are generated.

As shown in FIG. 1, in conventional display devices, a flip-chip film 20′ having a source driving chip 10′ needs to be connected to a plurality of data lines 101′ of a display panel 100′. When the display panel 100′ is a conventional display panel having higher resolution, a number of flip-chip films is determined to use according to resolution and a number of data signal outputting channels of source driver. Many flip-chip films are often required to use under higher resolution, and each flip-chip film needs to drive a like number of data lines 101′, increasing manufacturing costs significantly.

### SUMMARY

The object of the present disclosure is to provide a display device, which can accomplish a time-sharing multiplex flip-chip film to control data lines of a display panel respectively, thereby saving a number of flip-chip films and reducing manufacturing costs.

The object of the present disclosure is further to provide a method of driving a display device, which can accomplish a time-sharing multiplex flip-chip film to control data lines of a display panel respectively, thereby saving a number of flip-chip films and reducing manufacturing costs.

In order to accomplish the above objects, the present disclosure provides a display device, including: a display panel; and a flip-chip film connected to the display panel;

wherein a multiple multiplex module and a plurality of data lines connected to the multiple multiplex module are disposed in the display panel;

wherein the multiple multiplex module includes a plurality of switching thin-film transistors corresponding to the plurality of data lines respectively, a source electrode of each switching thin-film transistor is electrically connected to the flip-chip film, a drain electrode of the each switching thin-film transistor is electrically connected to a corresponding data line, and a switching control signal is inputted to a gate electrode of the each switching thin-film transistor;

wherein the plurality of switching thin-film transistors are divided into at least one switching thin-film transistor group every M switching thin-film transistors, where M is a positive integer greater than or equal to 2; and wherein the switching control signal is inputted to the at least one switching thin-film transistor group, and multiple switching control signals corresponding to multiple switching thin-film transistor groups respectively are different.

The multiple switching control signals corresponding to the multiple switching thin-film transistor groups respectively control the multiple switching thin-film transistor groups to be turned on sequentially.

A source driving chip is disposed on the flip-chip film and is connected to the plurality of switching thin-film transistors, and the source driving chip is configured to sequentially transmit data signals to the plurality of data lines through the multiple switching thin-film transistor groups.

A number of data signal outputting channels of the source driving chip is M.

M switching thin-film transistors of each switching thin-film transistor group correspond to M data signal outputting channels of the source driving chip respectively.

The plurality of switching thin-film transistors are N-type thin-film transistors.

The present disclosure further provides a method of driving a display device, including:

(S1) providing a display device including a display panel and a flip-chip film connected to the display panel;

wherein a multiple multiplex module and a plurality of data lines connected to the multiple multiplex module are disposed in the display panel;

wherein the multiple multiplex module includes a plurality of switching thin-film transistors corresponding to the plurality of data lines respectively, a source electrode of each switching thin-film transistor is electrically connected to the flip-chip film, a drain electrode of the each switching thin-film transistor is electrically connected to a corresponding data line, and a switching control signal is inputted to a gate electrode of the each switching thin-film transistor;

wherein the plurality of switching thin-film transistors are divided into at least one switching thin-film transistor group every M switching thin-film transistors, where M is a positive integer greater than or equal to 2; and wherein the switching control signal is inputted to the at least one switching thin-film transistor group, and multiple switching control signals corresponding to multiple switching thin-film transistor groups respectively are different;

(S2) controlling, by the multiple switching control signals corresponding to the multiple switching thin-film transistor groups respectively, the multiple switching thin-film transistor groups to be turned on sequentially; and

(S3) transmitting, by the flip-chip film, data signals to the plurality of data lines sequentially through the multiple switching thin-film transistor groups.

A source driving chip is disposed on the flip-chip film and is connected to the plurality of switching thin-film transistors, and in step S3, the source driving chip is configured to sequentially transmit the data signals to the plurality of data lines through the multiple switching thin-film transistor groups.

A number of data signal outputting channels of the source driving chip is M.

M switching thin-film transistors of each switching thin-film transistor group correspond to M data signal outputting channels of the source driving chip respectively.

The beneficial effect of the present disclosure is that, the display device includes a display panel and a flip-chip film connected to the display panel; wherein a multiple multiplex module and a plurality of data lines connected to the multiple multiplex module are disposed in the display panel; wherein the multiple multiplex module includes a plurality of switching thin-film transistors corresponding to the plurality of data lines respectively, a source electrode of each switching thin-film transistor is electrically connected to the flip-chip film, a drain electrode of the each switching thin-film transistor is electrically connected to a corresponding data line, and a switching control signal is inputted to a gate electrode of the each switching thin-film transistor; wherein the plurality of switching thin-film transistors are divided into at least one switching thin-film transistor group every M switching thin-film transistors, where M is a positive integer greater than or equal to 2; and wherein the switching control signal is inputted to the at least one switching thin-film transistor group, and multiple switching control signals corresponding to multiple switching thin-film transistor groups respectively are different. The switching thin-film transistors are disposed corresponding to the data lines, that is, the data lines are also divided into at least one data line group every M data lines. Each data line group is controlled by a switching control signal, and multiple switching control signals sequentially control multiple data line groups to receive data signals, so that the data lines of the display panel are controlled respectively to accomplish a time-sharing multiplex flip-chip film. Thus, a number of flip-chip films is saved, and manufacturing costs are reduced. In the present disclosure, the method of driving a display device can accomplish a time-sharing multiplex flip-chip film to control the data lines of the display panel respectively, thereby saving the number of flip-chip films and reducing the manufacturing costs.

### BRIEF DESCRIPTION OF DRAWINGS

In order to understand the features and the technical content of the present disclosure further, please refer to the detailed explanation and the accompanying drawings of the present disclosure as follows. However, the accompanying drawings are merely for reference and explanation without limiting the present disclosure.

The accompanying drawings are as follows:

FIG. 1 is a schematic diagram of a conventional display device.

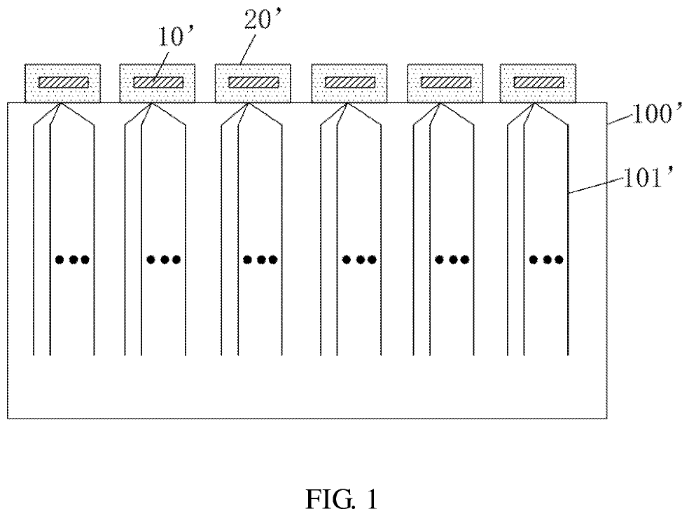

FIG. 2 is a schematic diagram of a display device of the present disclosure.

FIG. 3 is a flowchart illustrating a method of driving the display device of the present disclosure.

### DETAILED DESCRIPTION OF EMBODIMENTS

In order to explain the technical solutions and the effects of the present disclosure further, they will be described in conjunction with preferred embodiments and the accompanying drawings of the present disclosure in detail below.

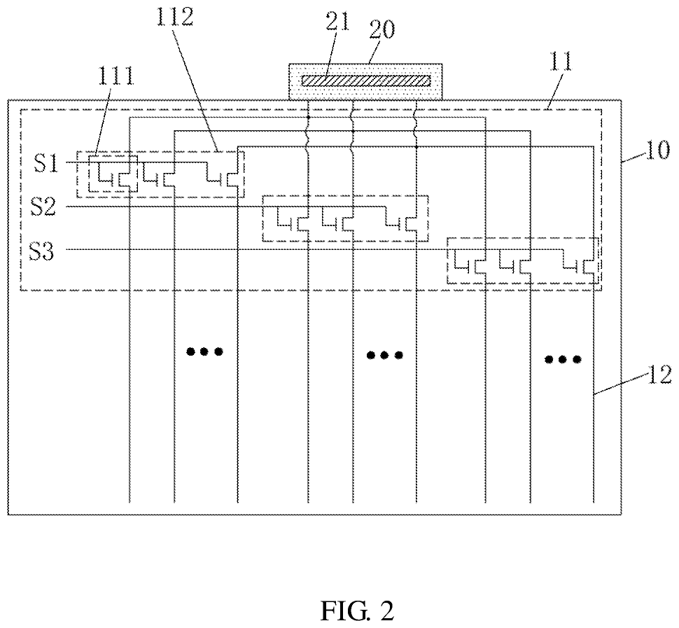

Please refer to FIG. 2, in which the present disclosure provides a display device including a display panel 10 and a flip-chip film 20 connected to the display panel 10.

A multiple multiplex module 11 and a plurality of data lines 12 connected to the multiple multiplex module 11 are disposed in the display panel 10.

The multiple multiplex module 11 includes a plurality of switching thin-film transistors 111 corresponding to the plurality of data lines 12 respectively. A source electrode of each switching thin-film transistor 111 is electrically connected to the flip-chip film 20, a drain electrode of each switching thin-film transistor 111 is electrically connected to a corresponding data line 12, and a switching control signal is inputted to a gate electrode of each switching thin-film transistor 111.

The plurality of switching thin-film transistors 111 are divided into at least one switching thin-film transistor group 112 every M switching thin-film transistors 111, where M is a positive integer greater than or equal to 2. The switching control signal is inputted to at least one switching thin-film transistor group 112, and multiple switching control signals corresponding to multiple switching thin-film transistor groups 112 respectively are different.

It needs to be stated that in the present disclosure, the multiple multiplex module 11 connected to the plurality of data lines 12 is disposed in the display panel 10. The multiple multiplex module 11 includes the plurality of switching thin-film transistors 111 corresponding to the plurality of data lines 12 respectively. The source electrode of each switching thin-film transistor 111 is electrically connected to the flip-chip film 20, the drain electrode of each switching thin-film transistor 111 is electrically connected to a corresponding data line 12, and the switching control signal is inputted to the gate electrode of each switching thin-film transistor 111. The plurality of switching thin-film transistors 111 are divided into at least one switching thin-film transistor group 112 every M switching thin-film transistors 111. The switching control signal is inputted to at least one switching thin-film transistor group 112, and multiple switching control signals corresponding to multiple switching thin-film transistor groups 112 respectively are different. That is, a number of switching control signals is the same as that of groups of switching thin-film transistors 111. The switching thin-film transistors 111 are disposed corresponding to the data lines 12, that is, the data lines 12 are also divided into at least one group of data lines 12 every M data lines 12. Each group of data lines 12 is controlled by a switching control signal, and multiple switching control signals sequentially control multiple groups of data lines 12 to receive data signals, so that a time-sharing multiplex flip-chip film 20 is accomplished. That is, in the present disclosure, the data lines 12 of the display panel 10 are controlled respectively through the multiple multiplex module 11 to accomplish the time-sharing multiplex flip-chip film 20. Thus, a number of flip-chip films 20 is saved, and manufacturing costs are reduced.

Specifically, the multiple switching control signals corresponding to the multiple switching thin-film transistor groups 112 respectively control the multiple switching thin-film transistor groups 112 to be turned on sequentially.

Specifically, a source driving chip 21 is disposed on the flip-chip film 20 and is connected to the plurality of switching thin-film transistors 111, and the source driving chip 21 is configured to sequentially transmit data signals to the plurality of data lines 12 through the multiple switching thin-film transistor groups 112. Thus, transmitting the data signals to the data lines 12 using a time-sharing method is accomplished.

Specifically, a number of data signal outputting channels of the source driving chip 21 is M. That is, a number of switching thin-film transistors 111 in a switching thin-film transistor group 112 is the same as that of data signal outputting channels of the source driving chip 21. That is to say, the number of switching thin-film transistors 111 in each switching thin-film transistor group 112 is disposed according to the number of data signal outputting channels of the source driving chip 21.

Further, M switching thin-film transistors 111 of each switching thin-film transistor group 112 correspond to M data signal outputting channels of the source driving chip 21 respectively.

Specifically, the plurality of switching thin-film transistors 111 are N-type thin-film transistors.

Specifically, the display panel 10 includes a display area and a non-display area surrounding the display area. The multiple multiplex module 11 is disposed in the non-display area of the display panel 10. The data lines 12 are located in the display area of the display panel 10.

For example, in the present disclosure, the plurality of switching thin-film transistors 111 are divided into three switching thin-film transistor groups 112. A first switching control signal S1 is inputted to a first switching thin-film transistor group 112, a second switching control signal S2 is inputted to a second switching thin-film transistor group 112, and a third switching control signal S3 is inputted to a third switching thin-film transistor group 112. While the display panel 10 is driven, first, the first switching control signal S1 controls the first switching thin-film transistor group 112 to be turned on; secondly, the second switching control signal S2 controls the second switching thin-film transistor group 112 to be turned on, the first switching control signal S1 and the third switching control signal S3 control the first and third switching thin-film transistor groups 112 to be cut off respectively, the source driving chip 21 transmits the data signals to M data lines 12 corresponding to the second switching thin-film transistor group 112; and lastly, the third switching control signal S3 controls the third switching thin-film transistor group 112 to be turned on, the first switching control signal S1 and the second switching control signal S2 control the first and second switching thin-film transistor groups 112 to be cut off respectively, the source driving chip 21 transmits the data signals to M data lines 12 corresponding to the third switching thin-film transistor group 112.

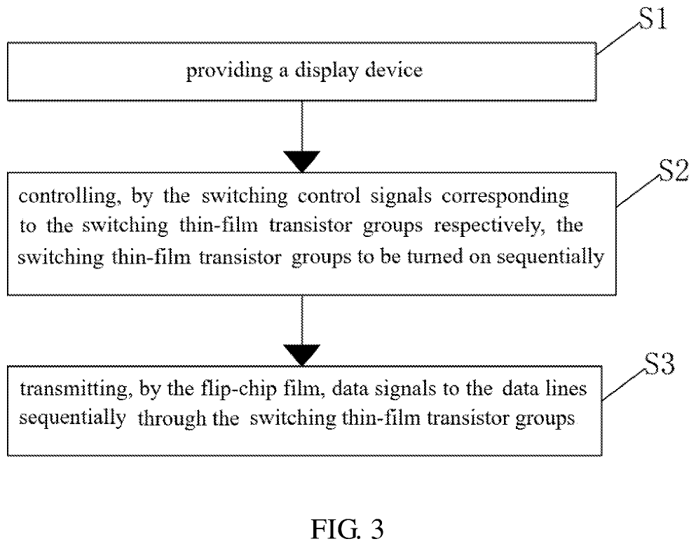

Please refer to FIG. 3. Based on the above display device, the present disclosure further provides a method of driving a display device, including the following steps:

Step S1: please refer to FIG. 2, in which providing a display device including the display panel 10 and the flip-chip film 20 connected to the display panel 10.

The multiple multiplex module 11 and the plurality of data lines 12 connected to the multiple multiplex module 11 are disposed in the display panel 10.

The multiple multiplex module 11 includes the plurality of switching thin-film transistors 111 corresponding to the plurality of data lines 12 respectively. The source electrode of each switching thin-film transistor 111 is electrically connected to the flip-chip film 20, the drain electrode of each switching thin-film transistor 111 is electrically connected to a corresponding data line 12, and the switching control signal is inputted to the gate electrode of each switching thin-film transistor 111.

The plurality of switching thin-film transistors 111 are divided into at least one switching thin-film transistor group 112 every M switching thin-film transistors 111, where M is a positive integer greater than or equal to 2. The switching control signal is inputted to at least one switching thin-film transistor group 112, and multiple switching control signals corresponding to multiple switching thin-film transistor groups 112 respectively are different.

Step S2: controlling, by the multiple switching control signals corresponding to the multiple switching thin-film transistor groups 112 respectively, the multiple switching thin-film transistor groups 112 to be turned on sequentially.

Step S3: transmitting, by the flip-chip film 20, data signals to the plurality of data lines 12 sequentially through the multiple switching thin-film transistor groups 112.

It needs to be stated that in the present disclosure, the multiple multiplex module 11 connected to the plurality of data lines 12 is disposed in the display panel 10. The multiple multiplex module 11 includes the plurality of switching thin-film transistors 111 corresponding to the plurality of data lines 12 respectively. The source electrode of each switching thin-film transistor 111 is electrically connected to the flip-chip film 20, the drain electrode of each switching thin-film transistor 111 is electrically connected to a corresponding data line 12, and the switching control signal is inputted to the gate electrode of each switching thin-film transistor 111. The plurality of switching thin-film transistors 111 are divided into at least one switching thin-film transistor group 112 every M switching thin-film transistors 111. The switching control signal is inputted to at least one switching thin-film transistor group 112, and multiple switching control signals corresponding to multiple switching thin-film transistor groups 112 respectively are different. That is, a number of switching control signals is the same as that of groups of switching thin-film transistors 111. The switching thin-film transistors 111 are disposed corresponding to the data lines 12, that is, the data lines 12 are also divided into at least one group of data lines 12 every M data lines 12. Each group of data lines 12 is controlled by a switching control signal, and multiple switching control signals sequentially control multiple groups of data lines 12 to receive data signals, so that a time-sharing multiplex flip-chip film 20 is accomplished. That is, in the present disclosure, the data lines 12 of the display panel 10 can be controlled respectively to accomplish the time-sharing multiplex flip-chip film 20. Thus, a number of flip-chip films 20 is saved, and manufacturing costs are reduced.

Specifically, the source driving chip 21 is disposed on the flip-chip film 20 and is connected to the plurality of switching thin-film transistors 111, and in step S3, the source driving chip 21 is configured to sequentially transmit the data signals to the plurality of data lines 12 through the multiple switching thin-film transistor groups 112.

Specifically, the number of data signal outputting channels of the source driving chip 21 is M. That is, the number of switching thin-film transistors 111 in a switching thin-film transistor group 112 is the same as that of data signal outputting channels of the source driving chip 21. That is to say, the number of switching thin-film transistors 111 in each switching thin-film transistor group 112 is disposed according to the number of data signal outputting channels of the source driving chip 21.

Further, M switching thin-film transistors 111 of each switching thin-film transistor group 112 correspond to M data signal outputting channels of the source driving chip 21 respectively.

Specifically, the plurality of switching thin-film transistors 111 are N-type thin-film transistors.

Specifically, the display panel 10 includes the display area and the non-display area surrounding the display area. The multiple multiplex module 11 is disposed in the non-display area of the display panel 10. The data lines 12 are located in the display area of the display panel 10.

For example, in the present disclosure, the plurality of switching thin-film transistors 111 are divided into three switching thin-film transistor groups 112. A first switching control signal S1 is inputted to a first switching thin-film transistor group 112, a second switching control signal S2 is inputted to a second switching thin-film transistor group 112, and a third switching control signal S3 is inputted to a third switching thin-film transistor group 112. While the display panel 10 is driven, first, the first switching control signal S1 controls the first switching thin-film transistor group 112 to be turned on; secondly, the second switching control signal S2 controls the second switching thin-film transistor group 112 to be turned on, the first switching control signal S1 and the third switching control signal S3 control the first and third switching thin-film transistor groups 112 to be cut off respectively, the source driving chip 21 transmits the data signals to M data lines 12 corresponding to the second switching thin-film transistor group 112; and lastly, the third switching control signal S3 controls the third switching thin-film transistor group 112 to be turned on, the first switching control signal S1 and the second switching control signal S2 control the first and second switching thin-film transistor groups 112 to be cut off respectively, the source driving chip 21 transmits the data signals to M data lines 12 corresponding to the third switching thin-film transistor group 112.

In conclusion, the display device includes a display panel and a flip-chip film connected to the display panel; wherein a multiple multiplex module and a plurality of data lines connected to the multiple multiplex module are disposed in the display panel; wherein the multiple multiplex module includes a plurality of switching thin-film transistors corresponding to the plurality of data lines respectively, a source electrode of each switching thin-film transistor is electrically connected to the flip-chip film, a drain electrode of the each switching thin-film transistor is electrically connected to a corresponding data line, and a switching control signal is inputted to a gate electrode of the each switching thin-film transistor; wherein the plurality of switching thin-film transistors are divided into at least one switching thin-film transistor group every M switching thin-film transistors, where M is a positive integer greater than or equal to 2; and wherein the switching control signal is inputted to the at least one switching thin-film transistor group, and multiple switching control signals corresponding to multiple switching thin-film transistor groups respectively are different. The switching thin-film transistors are disposed corresponding to the data lines, that is, the data lines are also divided into at least one data line group every M data lines. Each data line group is controlled by a switching control signal, and multiple switching control signals sequentially control multiple data line groups to receive data signals, so that the data lines of the display panel are controlled respectively to accomplish a time-sharing multiplex flip-chip film. Thus, a number of flip-chip films is saved, and manufacturing costs are reduced. In the present disclosure, the method of driving a display device can accomplish a time-sharing multiplex flip-chip film to control the data lines of the display panel respectively, thereby saving the number of flip-chip films and reducing the manufacturing costs.

A person of ordinary skill in the art is able to make modifications or changes corresponding to the foregoing description based on the technical solutions and the technical ideas of the present disclosure, and all of these modifications and changes should be within the protective scope of the appended claims of the present disclosure.

What is claimed is:

1. A display device, comprising:
a display panel; and
a flip-chip film connected to the display panel;
wherein a multiple multiplex module and a plurality of data lines connected to the multiple multiplex module are disposed in the display panel;
wherein the multiple multiplex module comprises a plurality of switching thin-film transistors corresponding to the plurality of data lines respectively, a source electrode of each switching thin-film transistor is electrically connected to the flip-chip film, a drain electrode of the each switching thin-film transistor is electrically connected to a corresponding data line, and a switching control signal is inputted to a gate electrode of the each switching thin-film transistor;
wherein the plurality of switching thin-film transistors are divided into at least one switching thin-film transistor group every M switching thin-film transistors, where M is a positive integer greater than or equal to 2; and
wherein the switching control signal is inputted to the at least one switching thin-film transistor group, and multiple switching control signals corresponding to multiple switching thin-film transistor groups respectively are different.

2. The display device of claim 1, wherein the multiple switching control signals corresponding to the multiple switching thin-film transistor groups respectively control the multiple switching thin-film transistor groups to be turned on sequentially.

3. The display device of claim 2, wherein a source driving chip is disposed on the flip-chip film and is connected to the plurality of switching thin-film transistors, and the source driving chip is configured to sequentially transmit data signals to the plurality of data lines through the multiple switching thin-film transistor groups.

4. The display device of claim 3, wherein a number of data signal outputting channels of the source driving chip is M.

5. The display device of claim 4, wherein M switching thin-film transistors of each switching thin-film transistor group correspond to M data signal outputting channels of the source driving chip respectively.

6. The display device of claim 1, wherein the plurality of switching thin-film transistors are N-type thin-film transistors.

7. A method of driving a display device, comprising:
(S1) providing a display device comprising a display panel and a flip-chip film connected to the display panel;
wherein a multiple multiplex module and a plurality of data lines connected to the multiple multiplex module are disposed in the display panel;
wherein the multiple multiplex module comprises a plurality of switching thin-film transistors corresponding to the plurality of data lines respectively, a source electrode of each switching thin-film transistor is electrically connected to the flip-chip film, a drain electrode of the each switching thin-film transistor is electrically connected to a corresponding data line, and a switching control signal is inputted to a gate electrode of the each switching thin-film transistor;
wherein the plurality of switching thin-film transistors are divided into at least one switching thin-film transistor group every M switching thin-film transistors, where M is a positive integer greater than or equal to 2; and
wherein the switching control signal is inputted to the at least one switching thin-film transistor group, and multiple switching control signals corresponding to multiple switching thin-film transistor groups respectively are different;
(S2) controlling, by the multiple switching control signals corresponding to the multiple switching thin-film transistor groups respectively, the multiple switching thin-film transistor groups to be turned on sequentially; and
(S3) transmitting, by the flip-chip film, data signals to the plurality of data lines sequentially through the multiple switching thin-film transistor groups.

8. The method of claim 7, wherein a source driving chip is disposed on the flip-chip film and is connected to the plurality of switching thin-film transistors, and in step S3, the source driving chip is configured to sequentially transmit the data signals to the plurality of data lines through the multiple switching thin-film transistor groups.

9. The method of claim 8, wherein a number of data signal outputting channels of the source driving chip is M.

10. The method of claim 9, wherein M switching thin-film transistors of each switching thin-film transistor group correspond to M data signal outputting channels of the source driving chip respectively.
